(19) United States
(12) Patent Application Publication
(10) Pub. No.: US 2022/0104663 A1
(43) Pub. Date: Apr. 7, 2022

(54) MOVABLE SHOWER APPARATUS AND MOVABLE SHOWER SYSTEM COMPRISING SAME

(71) Applicant: Yeonggwan HAN, Seoul (KR)

(72) Inventor: Yeonggwan HAN, Seoul (KR)

(21) Appl. No.: 17/421,090

(22) PCT Filed: Jan. 7, 2020
(86) PCT No.: PCT/KR2020/000287

§ 371 Date: Jul. 7, 2021

(30) Foreign Application Priority Data
Jan. 7, 2019 (KR) 10-2019-0001584

(51) Int. Cl. A47K 3/32; A47K 3/06; A61G 7/00; F24H 1/00

(52) U.S. Cl. CPC A47K 3/325; F24H 1/0072; A61G 7/0005; A47K 3/06

(57) ABSTRACT

A movable shower apparatus according to an embodiment of the present disclosure includes a body, a controller, a motor pump, a moving unit, and a purified water circulator. The body includes a purified water container and a wastewater container communicating with the purified water container. The controller provided on the body controls the flow rate and temperature of purified water. The motor pump draws the purified water from the purified water container and discharges the purified water. The moving unit carries the body. The purified water circulator draws external air, compresses the external air, and blows the compressed external air into the purified water container. The wastewater container allows the purified water in the purified water container to be introduced into the wastewater container. A heater is disposed within the purified water container to heat the purified water. The purified water circulator circulates the purified water from one side to the other side of the purified water container by blowing the compressed external air into the purified water container.

### CROSS REFERENCE TO RELATED APPLICATIONS AND CLAIM OF PRIORITY

This application claims benefit under 35 U.S.C. 119(e), 120, 121, or 365(c), and is a National Stage entry from International Application No. PCT/KR2020/000287, filed Jan. 7, 2020, which claims priority to the benefit of Korean Patent Application No. 10-2019-0001584 filed in the Korean Intellectual Property Office on Jan. 7, 2019, the entire contents of which are incorporated herein by reference.

### BACKGROUND

### 1. Technical Field

The present disclosure relates to a movable shower apparatus and a movable shower system including the same.

### 2. Background Art

These days, as society is aging, the elderly population is increasing significantly. In addition, although the number of persons with reduced mobility, such as patients and the handicapped, is increasing day by day, the reality is that the social system for such socially disadvantaged has not been sufficiently developed.

In particular, since the elderly and the weak have weak immunity, hygiene management is important. However, in a body washing process for such hygiene management, the elderly and the weak may be injured during movement for washing, or the use of a shower apparatus may be difficult. Thus, there are a number of difficulties in hygiene management for such persons.

Accordingly, the necessity for a movable shower apparatus has increased, and several movable shower apparatuses of the related art have been developed. However, most of these shower apparatuses are configured to use water supplied from an external source, and thus, must be disposed for use at a place in which a water supply for constantly supplying water is provided. It is impossible to use such shower apparatuses in a place in which continuous supply of water is difficult, or there is a difficulty in that a long hose must be connected from the water source to an actual shower room to be supplied with water. It is also difficult to adjust the amount, temperature, pressure of shower water, and post-treatment or the like of wastewater is also difficult.

### SUMMARY

Accordingly, embodiments of the present disclosure are intended to provide a movable shower apparatus configured such that a person whose body is to be cleaned may be washed without having to move to a specific place for washing and the clean hygienic state of the person may be easily maintained.

Embodiments of the present disclosure are also intended to provide a movable shower apparatus configured to be conveniently used in a place far from a water source or which does not have easy access to continuously supplied purified water, thereby providing convenience to users.

Embodiments of the present disclosure are also intended to provide a movable shower apparatus configured to process both purified water and wastewater at the same time, with a purified water container being located above a wastewater container.

According to an aspect of the present disclosure, provided is a movable shower apparatus including: a body including a purified water container accommodating purified water therein and a wastewater container accommodating wastewater therein, the wastewater container being connected to the purified water container in a fluid communicable manner; a controller provided on the body to control a flow rate and a temperature of the purified water; a motor pump configured to draw the purified water stored in the purified water container and discharge the purified water; a moving unit configured to carry the body; and a purified water circulator communicating with the outside of the body, and configured to draw external air, compress the drawn external air, and blow the compressed external air into the purified water container. The wastewater container may be located below the purified water container, thereby allowing the purified water in the purified water container to be introduced into the wastewater container. A heater heating the purified water in the purified water container may be disposed within the purified water container. The purified water circulator may circulate the purified water in the purified water container from one side to the other side of the purified water container by blowing the compressed external air into the purified water container.

The purified water circulator may include: an air inlet communicating with the outside of the body and configured to draw external air; an intake compressor connected to the air inlet and configured to compress the external air drawn by the air inlet; and a compressed air conveying pipe connecting the intake compressor and the purified water container to communicate with each other.

The distal end of the compressed air conveying pipe may be located within the purified water container, on one side in a horizontal direction. The compressed external air may be blown toward a bottom portion of the purified water container.

Each of the purified water container and the wastewater container may be implemented as a rigid body.

The movable shower apparatus may further include a drainage member located between the purified water container and the wastewater container and having a hollow structure allowing fluid to flow therethrough.

The drainage member may include a first valve disposed thereon to open and close a flow path in the drainage member.

The purified water container and the wastewater container may be formed integrally. The movable shower apparatus may further include a separator located between the purified water container and the wastewater container to limit movement of fluid therebetween.

The separator may include: an open area extending through at least a portion of the separator; and a second valve disposed in the open area and configured to open and close the open area.

The wastewater container may include a wastewater outlet protruding outward from the body and allowing the wastewater to be discharged therethrough.

Also provided is a movable shower system including: one of the above-described movable shower apparatuses; and a simple bathtub that movable or configured to disassembled and assembled.

According to embodiments of the present disclosure, a person whose body is to be cleaned may be washed without having to move to a specific place for washing, and the clean hygienic state of the person may be easily maintained

In addition, embodiments of the present disclosure may be conveniently used in a place far from a water source or which does not have easy access to continuously supplied purified water, thereby providing convenience to users.

In addition, according to embodiments of the present disclosure, it is possible to process both purified water and wastewater at the same time, with the purified water container being located above the wastewater container.

### BRIEF DESCRIPTION OF THE DRAWINGS

FIG. 1 is a view illustrating a movable shower system including a movable shower apparatus according to an embodiment of the present disclosure;

FIG. 2A is a cross-sectional view of the movable shower apparatus according to an embodiment of the present disclosure;

FIG. 2B is a cross-sectional view of a movable shower apparatus according to another embodiment of the present disclosure; and

FIG. 3 is a view illustrating a purified water container and a wastewater container according to yet another embodiment of the present disclosure.

### DETAILED DESCRIPTION

Hereinafter, specific embodiments of the present disclosure will be described with reference to the accompanying drawings. It should be understood, however, the description is provided for illustrative purposes only and not provided to limit the present disclosure.

In the following description of the present disclosure, detailed descriptions of known technologies related to the present disclosure will be omitted in the situation in which the description may make the subject matter of the present disclosure rather unclear. Terms to be used hereinafter will be defined in consideration of functions thereof used in the present disclosure, and may vary depending on the intentions of users or operators, as well as practices. Therefore, the terms should be defined on the basis of the entire description of the present specification.

The technical principle of the present disclosure is defined by the Claims. The following embodiments are merely a means for effectively describing the technical principle of the present disclosure to a person having ordinary knowledge in the technical field to which the present disclosure pertains.

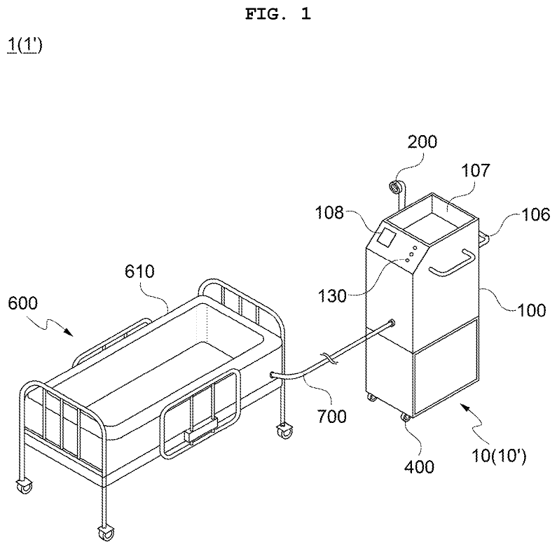

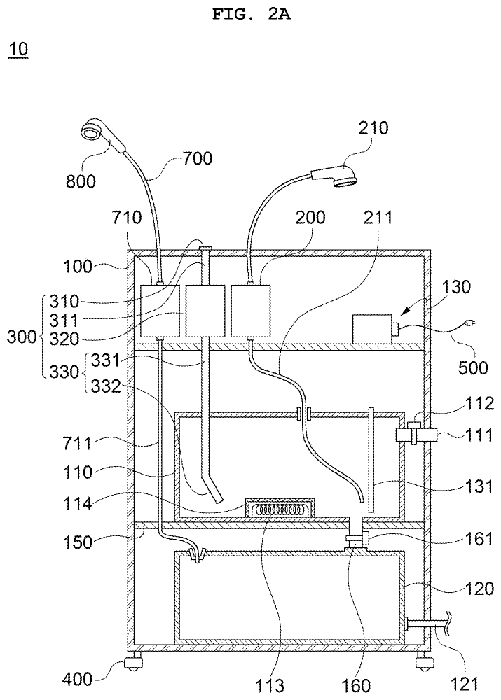

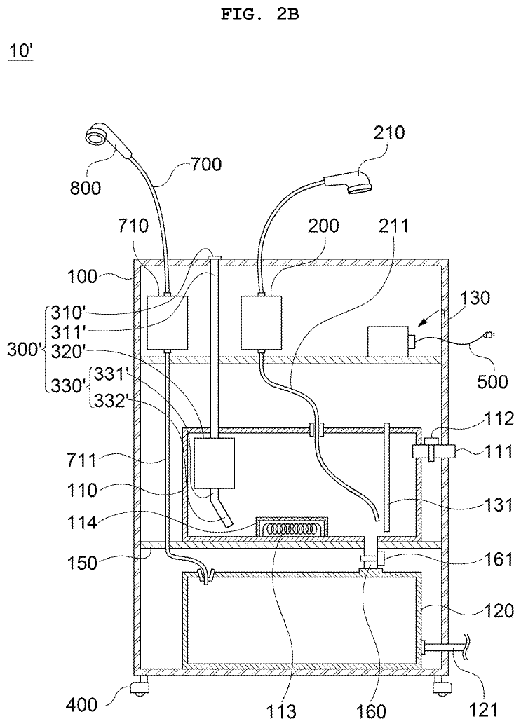

FIG. 1 is a view illustrating a movable shower system including a movable shower apparatus according to an embodiment of the present disclosure, and FIG. 2A is a cross-sectional view of the movable shower apparatus according to an embodiment of the present disclosure.

Referring to FIGS. 1 and 2A, a movable shower apparatus 10 according to an embodiment of the present disclosure may include a body 100 and a moving unit 400 configured to carry the body 100. The body 100 internally includes a purified water container 110 accommodating purified water therein and a wastewater container 120 accommodating wastewater therein. The purified water container 110 and the wastewater container 120 are disposed inside the body 100 and connected to each other in a fluid communicable manner, in a manner in which fluid can flow therebetween. The movable shower apparatus 10 may include a motor pump 200 drawing the purified water stored in the purified water container 110 and discharging the purified water through a shower head 210 in order to allow a user to wash his or her body. In addition, the wastewater container 120 is located below the purified water container 110, such that the purified water from the purified water container 110 may be introduced into the wastewater container 120 by gravity.

The body 100 may further include handles 106 on side surfaces. While the handles 106 may be provided on the side surfaces of the body 100 as illustrated in FIG. 1, the present disclosure is not limited thereto. The handles 106 may be provided on any portions reachable by hand. In addition, the handles 106 may also have any shape that may transfer force from the user to the body 100 while being grasped by hand. The handles 106 may facilitate the movement of the body 100.

In addition, the body 100 may further include a receptacle 107 in which goods may be accommodated. Thus, bath products necessary for washing or the like may be equipped, and the convenience of the user in the use of the movable shower apparatus 10 may be improved. Furthermore, the body 100 may further include a display window 108 displaying the state, such as the temperature or the pressure, of the purified water. This may allow the temperature, the pressure, or the like of the purified water to be reviewed in real time, thereby improving the convenience of the user.

Specifically, a purified water inlet 111 may be provided on a side portion of the purified water container 110 to protrude from the purified water container 110 to the outside of the body 100. Here, the purified water inlet 111 may connect the inside of the purified water container 110 and the outside of the body 100 so as to communicate with each other. Thus, the purified water may be introduced to the purified water container 110 through the purified water inlet 111 from an external source, and the purified water container 110 may accommodate the introduced purified water.

Here, the purified water container 110 may include a third valve 112. The third valve 112 may be implemented as a solenoid valve so as to adjust the opening/closing of the purified water inlet 111 under the control of a controller 130. However, the third valve 112 is not limited thereto, and may be implemented as any structure capable of opening and closing a flow path. The third valve 112 may also be implemented as a manual valve, such as a ball valve or a gate valve.

In addition, the purified water inlet 111 may further include a filter (not shown) filtering the purified water introduced thereto. Thus, cleaner water may be provided, and thus, when a person being washed is a patient, it may be more advantageous in improving the person's state of sickness.

Furthermore, a heater 113 heating the purified water in the purified water container may be disposed on a portion within the purified water container 110. The operation and the heating temperature of the heater 113 may be controlled by the controller 130 to be described later. Accordingly, it is possible to heat the purified water stored in the purified water container 110 at a temperature desired by the user, thereby providing convenience to the user. Here, the heater 113 may be implemented as an electric heating wire. However, this is merely an example, and the heater is not limited thereto.

In addition, the heater 113 may be disposed on the bottom surface within the purified water container 110, and a protective cap 114 may be provided on or above the heater 113. The heater protection cap 114 may be coupled to the bottom surface of the purified water container 110 and fix the heater 113 to the bottom. portion. of the purified water container 110. Here, the heater protection cap 114 may be provided in the shape of a frame having a number of voids and configured to surround the heater 113. The heater protection cap 114 may prevent the heater 113 from being released or dislodged from the purified water container 110 by external impact or the like.

In addition, the movable shower apparatus 10 according to an embodiment of the present disclosure may further include a purified water circulator 300 communicating with the outside of the body 100, and configured to draw external air, compress the drawn external air, and blow the compressed external air into the purified water container 110. Here, the purified water circulator 300 may circulate the purified water in the purified water container 110 from one side to the other side of the purified water container (to move in a horizontal direction or a vertical direction) by convection by blowing the compressed air into the purified water container 110.

Accordingly, when the purified water in the purified water container 110 is heated by the heater 113, the entirety of the purified water in the purified water container 110 may be uniformly heated. That is, instead of a heat transfer process in which a portion of the purified water close to the heater 113 is heated and the remaining portion of the purified water is sequentially heated by simple thermal conduction, convection heat transfer may also be performed by the circulation of the purified water, thereby improving the efficiency of energy of the heater 113.

Specifically, the purified water circulator 300 may include: an air inlet 310 communicating with the outside of the body 100 and configured to draw external air, with at least a portion of the air inlet 310 being exposed to the outside of the body 100; an intake compressor 320 located above the purified water container 110 inside the body 100 and connected to the air inlet 310 to compress the external air drawn by the air inlet 310; and a compressed air conveying pipe 330 connecting the intake compressor 320 and the purified water container 110 to communicate with each other.

Here, the purified water circulator 300 may further include a drawn air conveying pipe 311 connecting the air inlet 310 and the intake compressor 320.

In addition, one end of the compressed air conveying pipe 330 may be connected to the intake compressor 320 and the other end of the intake compressor 320 may be located on one side of the purified water container 110 in the horizontal direction. Here, the other end of the compressed air conveying pipe 330 may be located to face the bottom portion of the purified water container 110. The compressed external air may be blown toward the bottom surface of the purified water container 110.

More specifically, the above-described compressed air conveying pipe 330 may include a first compressed air conveying pipe 331 extending from the intake compressor 320 perpendicularly to the ground and a second compressed air conveying pipe 332 extending in a predetermined direction bent by a predetermined angle from the distal end of the first compressed air conveying pipe 331. Here, the distal end of the second compressed air conveying pipe 332 may be at the predetermined angle bent with respect to the longitudinal direction of the first compressed air conveying pipe 331 so as to face the inner bottom surface of the purified water container 110.

As described above, the compressed external air blown through the compressed air conveying pipe 330 may be blown toward the bottom surface of the purified water container 110 in one side in the horizontal direction within the purified water container 110, thereby causing a circulation (or convection) in one direction (i.e., the counterclockwise direction in the drawings) within the entire purified water container 110. Furthermore, the blown compressed external air circulates after having collided with the bottom surface of the purified water container 110. This may induce turbulence in the purified water, thereby improving the efficiency of heat transfer.

In addition, the above-described intake compressor 320 may include an intake valve (not shown), a cylinder chamber (not shown), a piston (not shown), a crank (not shown), motor (not shown), and the like, for compression of the drawn external air. However, these components are illustrative only, and the intake compressor is not limited thereto.

Furthermore, a detector 131 may be disposed on the purified water container 110. The detector 131 may detect the level and temperature of the purified water, with at least a portion of the detector 131 being located within the purified water container 110. The detector 131 may be electrically connected to the display window 108 of the body 100 through the controller 130 to be described later, so as to provide the level and temperature information of the purified water within the purified water container 110 to the user in real time.

The movable shower apparatus 10 according to an embodiment of the present disclosure may also include the controller 130 provided on the body 100 to control the flow rate and temperature of the purified water. Specifically, the controller 130 may be connected to the above-described components, such as the purified water circulation pump 300, the motor pump 200, the third valve 112, the detector 131, and the heater 113, through wiring (not shown) in the body 100 to control the operations of the components. In addition, the controller 130 may be supplied with power from an external source through a power supply 500 electrically connected to a portion thereof.

In addition, each of the purified water container 110 and the wastewater container 120 described above may be implemented as a rigid body. The body 100 may further include a support plate 150 supporting the purified water container 110. In addition, the movable shower apparatus 10 according to an embodiment of the present disclosure may further include a drainage member 160 located between the purified water container 110 and the wastewater container 120 to extend through the support plate 150. Here, the drainage member 160 connects the purified water container 110 and the wastewater container 120, and has a hollow structure allowing the fluid to flow therethrough.

Due to this configuration, the purified water within the purified water container 110 may be directly conveyed to the wastewater container 120 through the drainage member 160. Since the purified water container 110 is located above the wastewater container 120, the purified water may be introduced by gravity to the wastewater container 120 located below. Accordingly, the purified water may be conveyed without extra power.

In addition, the drainage member 160 may include a first valve 161 configured to open and close a flow path within the drainage member 160. Accordingly, when the user washes using the purified water in the purified water container 110, the user may reliably use the purified water by closing the flow path in the drainage member 160. After the use of the purified water is finished, the user may easily discharge the purified water remaining in the purified water container 110 by opening the flow path of the drainage member 160.

Here, the first valve 161 may be implemented as a solenoid valve to be electrically connected to the controller 130, and the controller 130 may control the flow path within the drainage member 160 to be opened and closed however, the type of the first valve 161 is not limited thereto and any type of valve capable of opening and closing the flow path may suffice. A manual valve, such as a ball valve or a gate valve, may also be used.

In addition, the wastewater container 120 may include a wastewater outlet 121 protruding outward from the body 100, allowing the wastewater to be discharged therethrough. Thus, when the wastewater container 120 is filled with the wastewater, it is possible to discard the wastewater without separating the wastewater container 120 from the body 100. As described above, the purified water introduced through the drainage member 160 may also be discharged together with the wastewater through the wastewater outlet 121.

In addition, the wastewater outlet 121 may be provided on a portion of the lowermost portion of the wastewater container 120 such that, when the wastewater is discharged from the wastewater container 120, the wastewater may be completely discharged without remaining in the wastewater container 120. Here, an opening and closing member (not shown), such as a valve (not shown), configured to open and close the wastewater outlet 121 may be provided to adjust the discharge of the wastewater.

Furthermore, in the movable shower apparatus 10 according to an embodiment of the present disclosure, a suction pump 710 may be provided within the body 100 to draw external fluid into the wastewater container 120. Specifically, the suction pump 710 is connected to an intake device 800 through a wastewater transfer line 700. After the user has finished washing, the suction pump 710 may draw the remaining wastewater from a simple bathtub 600 and convey the drawn wastewater to the wastewater container 120. The wastewater drawn to the wastewater container 120 may be discharged through the wastewater outlet 121 as described above.

In addition, the movable shower apparatus 10 according to an embodiment of the present disclosure may further include a spare motor pump (not shown) and a spare suction pump (not shown). Specifically, the spare pumps may be disposed on one side of the motor pump 200 and one side of the suction pump 710, respectively. When any of the pumps 200 and 710 malfunctions during the use of the movable shower apparatus 10, a first conveying pipe 211 connected to the motor pump 200 or a third conveying pipe 711 connected to the suction pump 710 may be connected to the corresponding spare pump in order to use the connected spare pump.

In addition, a movable shower system 1 including the movable shower apparatus 10 according to an embodiment of the present disclosure may further include the simple bathtub 600. The simple bathtub 600 may include a mattress 610 having the shape of a bathtub. The mattress 610 may be implemented as a tube inflatable into the shape of a bathtub when filled with air. However, this is illustrative only and is not limiting. A simple movable bathtub may be used or a prefabricated bathtub capable of obtaining the shape of a bathtub by the assembly/disassembly of waterproof cloth may be used.

FIG. 2B is a cross-sectional view of a movable shower apparatus 10′ according to another embodiment of the present disclosure.

Referring to FIG. 2B, the movable shower apparatus 10′ according to another embodiment of the present disclosure may be realized by modifying the structure of the purified water circulator 300 of the movable shower apparatus 10 according to an embodiment of the present disclosure. That is, except for the purified water circulator 300 of the movable shower apparatus 10 according to an embodiment of the present disclosure, the other components have the same function, arrangement, and relationship therebetween, and thus, detailed descriptions of the other components will be omitted.

The movable shower apparatus 10′ according to another embodiment of the present disclosure may include a purified water circulator 300′ communicating with the outside of the body 100, and configured to draw external air, compress the drawn external air, and blow the compressed external air into the purified water container 110.

Here, the purified water circulator 300′ may include: an air inlet 310′ communicating with the outside of the body 100 and configured to draw external air, with at least a portion of the air inlet 310′ being exposed to the outside of the body 100; an intake compressor 320′ connected to the air inlet 310′ to compress the external air drawn by the air inlet 310′; and a compressed air conveying pipe 330′ connecting the intake compressor 320′ and the purified water container 110 to communicate with each other. In addition, the purified water circulator 300′ may further include a drawn air conveying pipe 311′ connecting the air inlet 310′ and the intake compressor 320′.

The above-described intake compressor 320′ may be located within the purified water container 110. In this case, since the length of the compressed air conveying pipe 330′ through which the compressed external air is conveyed is reduced, the length of movement from the intake compressor 320′ to the distal end of the compressed air conveying pipe 330′ may be reduced to be shorter than that of the above-described purified water circulator 300. That is, since the compressive force of external air blown from the purified water circulator 300′ may be further increased, the efficiency of convection of the purified water within the purified water container 110 may be increased, and the temperature of the purified water may be uniformly increased by the heater 113.

In addition, the compressed air conveying pipe 330′ may include a first compressed air conveying pipe 331′ and a second compressed air conveying pipe 332′. Here, the details of the bent structure of the compressed air conveying pipe 330′ are the same as those of the above-described compressed air conveying pipe 330 of the purified water circulator 300, and thus, a detailed description thereof will be omitted.

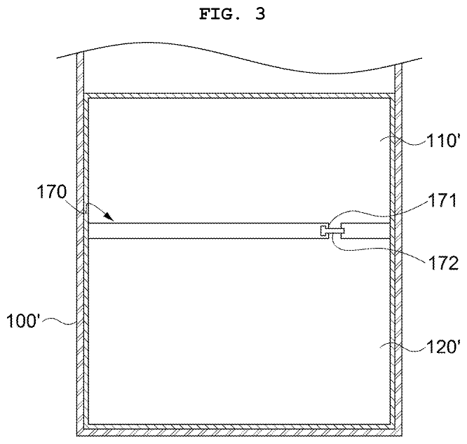

FIG. 3 is a view illustrating a purified water container 110′ and a wastewater container 120′ according to yet another embodiment of the present disclosure.

Referring to FIG. 3, the purified water container 110′ and the wastewater container 120′ may be formed as an integrated body. The movable shower apparatus according to yet another embodiment of the present disclosure may include a separator 170 located between the purified water container 110′ and the wastewater container 120′ to limit the movement of fluid therebetween. In addition, the separator 170 may include an open area 171 extending through at least a portion of the separator 170 and a second valve 172 disposed in the open area 171 and configured to open and close a flow path in the open area 171.

Specifically, the above-described components, i.e., the purified water container 110 and the wastewater container 120, according to an embodiment of the present disclosure are implemented as rigid bodies, and thus, may be connected to each other by the drainage member 160. In contrast, the purified water container 110′ and the wastewater container 120′ according to yet another embodiment of the present disclosure may be formed integrally on both sides of the separator 170. Since the purified water container 110′ and the wastewater container 120′ are formed integrally as described above, an additional connector member, such as the drainage member 160, is not required. Accordingly, the risk of fracture of the connecting portions of the components caused by external force, such as external impact, may be reduced, and reliably may be increased. In addition, the utilization of the space within the body 100 may be increased.

In addition, the second valve 172 may be implemented as a solenoid valve electrically connected to the controller 130. The opening and closing of the flow path in the open area 171 may be adjusted by the controller 130. However, the type of the second valve 172 is not limited thereto and any type of valve capable of opening and closing the flow path may suffice. A manual valve, such as a ball valve or a gate valve, may also be used.

As described above, according to the movable shower apparatus 10 according to an embodiment of the present disclosure, a person whose body is to be washed can be washed without having to move to a specific place for washing. Accordingly, it is possible to reduce the difficulty of such persons to move to a place in which the persons are to be washed, reduce a risk t persons to be washed may be injured, and reduce difficulties in the washing process.

In addition, the movable shower apparatus 10 according to an embodiment of the present disclosure may be easily used even in a place far from a water source or which does not have easy access to continuously supplied purified water, thereby providing convenience to users.

While the present disclosure has been described in detail hereinabove with respect to the exemplary embodiments thereof, a person having ordinary knowledge in the technical field to which the present disclosure pertains will appreciate that various modifications of the foregoing embodiments are possible without departing from the scope of the present disclosure. Therefore, the scope of protection of the present disclosure shall not be limited to the foregoing embodiments but shall be defined by the appended Claims and equivalents thereof.

1. A movable shower apparatus comprising:
a body comprising a purified water container accommodating purified water therein and a wastewater container accommodating wastewater therein, the wastewater container being connected to the purified water container in a fluid communicable manner;
a controller provided on the body to control a flow rate and a temperature of the purified water;
a motor pump configured to draw the purified water stored in the purified water container and discharge the purified water;
a moving unit configured to carry the body;
a purified water circulator communicating with the outside of the body, and configured to draw external air, compress the drawn external air, and blow the compressed external air into the purified water container, wherein the wastewater container is located below the purified water container, thereby allowing the purified water in the purified water container to be introduced into the wastewater container, and the purified water circulator circulates the purified water in the purified water container from one side to the other side of the purified water container by blowing the compressed external air into the purified water container; and
a heater disposed within the purified water container to heat the purified water in the purified water container.

2. The movable shower apparatus according to claim 1, wherein the purified water circulator comprises:
an air inlet communicating with the outside of the body and configured to draw external air;
an intake compressor connected to the air inlet and configured to compress the external air drawn by the air inlet; and
a compressed air conveying pipe connecting the intake compressor and the purified water container to communicate with each other.

3. The movable shower apparatus according to claim 2, wherein a distal end of the compressed air conveying pipe is located within the purified water container, on one side in a horizontal direction, and
the compressed external air is blown toward a bottom portion of the purified water container.

4. The movable shower apparatus according to claim 1, wherein each of the purified water container and the wastewater container comprises a rigid body.

5. The movable shower apparatus according to claim 4, further comprising a drainage member located between the purified water container and the wastewater container and having a hollow structure allowing fluid to flow therethrough.

6. The movable shower apparatus according to claim 5, wherein the drainage member comprises a first valve disposed thereon to open and close a flow path in the drainage member.

7. The movable shower apparatus according to claim 1, wherein the purified water container and the wastewater container are formed integrally,
the movable shower apparatus further comprising a separator located between the purified water container and the wastewater container to limit movement of fluid therebetween.

8. The movable shower apparatus according to claim 7, wherein the separator comprises:
an open area extending through at least a portion of the separator; and
a second valve disposed in the open area and configured to open and close the open area.

9. The movable shower apparatus according to claim 1, wherein the wastewater container comprises a wastewater outlet protruding outward from the body and allowing the wastewater to be discharged therethrough.

10. A movable shower system comprising:
the movable shower apparatus as claimed in claim 1; and
a simple bathtub that is movable or configured to be disassembled and assembled.
